(19) United States
(12) Patent Application Publication
(10) Pub. No.: US 2026/0131626 A1
(43) Pub. Date: May 14, 2026

(54) VEHICLE AIR CONDITIONING SYSTEM AND METHOD FOR CONTROLLING SAME

(71) Applicant: NGK INSULATORS, LTD., Nagoya-Shi (JP)

(72) Inventor: Takafumi HAMADA, Nagoya-Shi (JP)

(73) Assignee: NGK INSULATORS, LTD., Nagoya-Shi (JP)

(21) Appl. No.: 19/353,667

(22) Filed: Oct. 9, 2025

(30) Foreign Application Priority Data
Nov. 12, 2024 (JP) 2024-197744

(51) Int. Cl. B60H 1/00

(52) U.S. Cl. CPC B60H 1/00821

(57) ABSTRACT

A vehicle air conditioning system 1 includes: a humidity controlling device 2; a first flow path 3 for feeding air 10 to a vehicle interior without passing through the humidity controlling device 2; a second flow path 4 for feeding the air 10 through the humidity controlling device 2 to the vehicle interior; and a flow rate controller 5 for controlling a flow rate of the air 10 of the first flow path 3 and/or the second flow path 4 so that, when the air 10 is blown out from a defroster, a dehumidified air flow rate ratio, which is a ratio of a flow rate of the air 10 passing through the second flow path 4 to a total flow rate of the air passing through the first flow path 3 and the second flow path 4, is 5% or more.

### FIELD OF THE INVENTION

The present invention relates to a vehicle air conditioning system and a method for controlling the same.

### BACKGROUND OF THE INVENTION

In various types of vehicles such as automobiles, there are increasing requirements for improvement of vehicle interior environment. Specific requirements illustrate reduction of an amount of carbon dioxide in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

Patent Literature 1 described below discloses a vehicle interior purification system including a humidity controlling device (heater element) which a removal target component such as water vapor and CO₂ in the air in the vehicle interior is captured by a functional material such as an adsorbent, and the removal target component is then reacted or desorbed by heating to discharge them to a vehicle exterior and regenerate the functional material.

Further, as disclosed in Patent Literature 2 described below, air is blown against a vehicle window glass to remove fogging from the window glass. In order to reduce heat loss through ventilation during cold weather, outside air is partially introduced while circulating the inside air, to reduce the humidity of the air blown against the window glass.

### CITATION LIST

### Patent Literatures

[Patent Literature 1] Japanese Patent Application Publication No. 2024-101455 A
[Patent Literature 1] Japanese Patent Application Publication No. 2009-298323 A

### SUMMARY OF THE INVENTION

It is believed that an efficiency of removing the fogging from the window glass can be improved by using air that has passed through the humidity controlling device of Patent Literature 1 to remove the fogging from the window glass as in Patent Literature 2. However, depending on a proportion of air passing through the humidity controlling device in the total flow rate of air that has passed through the humidity controlling device and air that has not passed through the humidity controlling device, there is a risk that the removal of the fogging from the window glass may be insufficient.

This invention has been made to solve the problems described above, and one of objects thereof is to provide a vehicle air conditioning system and a method for controlling the same, which can more reliably remove the fogging from the vehicle glass window.

[1] In an embodiment, this invention relates to a vehicle air conditioning system, comprising: a humidity controlling device having an adsorption portion containing an adsorbent configured to adsorb moisture at a temperature lower than or equal to a predetermined temperature and to desorb the moisture when the temperature exceeds the predetermined temperature; a first flow path for feeding air from a vehicle interior or a vehicle exterior to the vehicle interior without passing through the humidity controlling device; a second flow path for feeding the air through the humidity controlling device to the vehicle interior; and a flow rate controller for controlling a flow rate of the air passing through the first flow path and/or the second flow path so that, when the air to the vehicle interior is blown out from a defroster, a dehumidified air flow rate ratio, which is a ratio of a flow rate of the air passing through the second flow path to a total flow rate of the air passing through the first flow path and the second flow path, is 5% or more.

[2] This invention may relate to the vehicle air conditioning system according to [1], wherein the flow rate controller comprises a blower for feeding the air to the humidity controlling device.

[3] This invention may relate to the vehicle air conditioning system according to [1] or [2], wherein the flow rate controller comprises a flow rate controlling valve provided in the first flow path.

[4] This invention may relate to the vehicle air conditioning system according to any one of [1] to [3], wherein the flow rate controller has the dehumidified air flow rate ratio of 7% or more.

[5] This invention may relate to the vehicle air conditioning system according to [4], wherein the flow rate controller has the dehumidified air flow rate ratio of 15% or more.

[6] The present invention may relate to the vehicle air conditioning system according to any one of [1] to [5], further comprising a humidity sensor for measuring humidity in the vehicle interior, wherein the flow rate controller changes the dehumidified air flow rate ratio based on the humidity measured by the humidity sensor.

[7] This invention may relate to the vehicle air conditioning system according to any one of [1] to [6], wherein the adsorption portion comprises: a honeycomb structure having an outer wall and partition walls provided on an inner side of the outer wall, the partition walls defining cells to form flow paths for the air, each of the cells extending from a first end face to a second end face of the honeycomb structure; and an adsorbing layer containing an adsorbent provided on a surface of each of the partition walls, and wherein the humidity controlling device has a pair of electrodes connected to the honeycomb structure, and further comprises a heating means for heating the honeycomb structure by passing a current through the honeycomb structure through the pair of electrodes, and at least the partition walls of the honeycomb structure are made of a material having a PTC property.

[8] In an embodiment, this invention relates to a method for controlling a vehicle air conditioning system, the vehicle air conditioning system comprising: a humidity controlling device having an adsorption portion containing an adsorbent configured to adsorb moisture at a temperature lower than or equal to a predetermined temperature and to desorb the moisture when the temperature exceeds the predetermined temperature; a first flow path for feeding air from a vehicle interior or a vehicle exterior to the vehicle interior without passing through the humidity controlling device; and a second flow path for feeding the air through the humidity controlling device to the vehicle interior, wherein the method comprises controlling a flow rate of the air passing through the first flow path and/or the second flow path so that, when the air to the vehicle interior is blown out from a defroster, a dehumidified air flow rate ratio, which is a ratio of a flow rate of the air passing through the second flow path to a total flow rate of the air passing through the first flow path and the second flow path, is 5% or more.

According to an embodiment of the vehicle air conditioning system and the method for controlling the same according to this invention, when air is blown out from the defroster into the vehicle interior, the dehumidified air flow rate ratio is 5% or more, so that the fogging of the window glass of the vehicle can be more reliably removed.

### BRIEF DESCRIPTION OF THE DRAWINGS

FIG. 1 is a schematic view of a vehicle air conditioning system according to an embodiment of the invention;

FIG. 2 is a schematic view illustrating a variation of a vehicle air conditioning system in FIG. 1;

FIG. 3 is a front view of a humidity controlling device in FIG. 1;

FIG. 4 is a right side view of a humidity controlling device in FIG. 3; and

FIG. 5 is an enlarged view illustrating a region V in FIG. 3.

### DETAILED DESCRIPTION OF THE INVENTION

Hereinafter, embodiments of the invention will be specifically described with reference to the drawings. The invention is not limited to each embodiment, and components can be modified and embodied without departing from the spirit of the invention. Further, various inventions can be formed by appropriately combining a plurality of components disclosed in each embodiment. For example, some components may be removed from all of the components shown in the embodiments. Furthermore, the components of different embodiments may be optionally combined.

### (1. Vehicle Air Conditioning System)

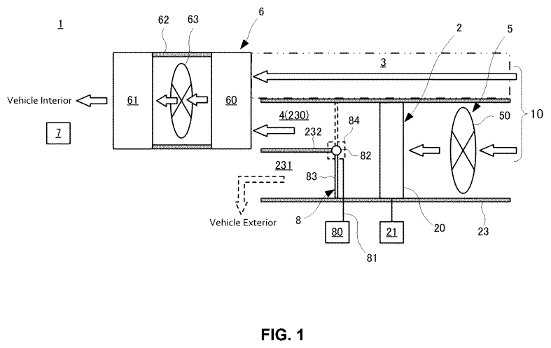

FIG. 1 is a schematic view of a vehicle air conditioning system 1 according to an embodiment of the invention. The vehicle air conditioning system 1 according to an embodiment is a system mounted on a vehicle. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the vehicle air conditioning system 1 according to an embodiment can be suitably used for a vehicle that has no internal combustion engine such as electric vehicles and electric rail cars.

As illustrated in FIG. 1, the vehicle air conditioning system 1 according to an embodiment of the invention includes a humidity controlling device 2, a first flow path 3, a second flow path 4, and a flow rate controller 5.

The humidity controlling device 2 has an adsorption portion 20. The adsorption portion 20 contains an adsorbent capable of adsorbing moisture at a temperature lower than or equal to a predetermined temperature and desorbing the moisture when the temperature exceeds the predetermined temperature.

The first flow path 3 is for feeding air 10 from the vehicle interior or vehicle exterior into the vehicle interior without passing through the humidity controlling device 2, and the second flow path 4 is for feeding the air 10 to the vehicle interior through the humidity controlling device 2. As the air 10 passes through the humidity controlling device 2, moisture in the air 10 can be adsorbed by the adsorbent. In other words, the air 10 that has passed through the humidity controlling device 2 or the second flow path 4 has been dehumidified.

The flow rate controller 5 is a device for controlling a flow rate of the air 10 passing through the first flow path 3 and/or the second flow path 4 so that, when the air 10 to the vehicle interior is blown out from a defroster, a dehumidified air flow rate ratio, which is a ratio of a flow rate of the air 10 passing through the second flow path 4 to a total flow rate of the air 10 passing through the first flow path 3 and the second flow path 4, is 5% or more.

The defroster is a blowing port for the air 10, which is provided so that the air 10 is blown against an inner surface of a window glass of the vehicle to remove the fogging from the window glass. The window glass includes a windshield and side windows, and the defroster may be located below the windshield and/or in front of and below the side windows.

An efficiency of removing the fogging from the window glass can be improved by using the air 10 that has passed through the humidity controlling device 2 or the second flow path 4 to remove the fogging from the window glass. However, depending on the dehumidified air flow rate ratio, there is a risk that the removal of the fogging from the window glass may be insufficient. As in the vehicle air conditioning system according to this embodiment, when the air 10 to the vehicle interior is blown out from the defroster, the dehumidified air flow rate ratio is 5% or more, so that the fogging of the window glass of the vehicle can be more reliably removed.

Each component of the vehicle air conditioning system 1 according to this embodiment will be described in detail.

The humidity controlling device 2 according to this embodiment is provided outside an HVAC unit 6. The HVAC system 6 is a unit for performing heating, ventilation, and air conditioning in a vehicle. The HVAC unit 6 has an HVAC intake port 60, an HVAC blow port 61, an HVAC duct 62, and an HVAC blower 63. The HVAC blower 63 is disposed inside the HVAC duct 62 between the HVAC intake port 60 and the HVAC blow port 61. The HVAC blower 63 is disposed inside the HVAC duct 62 between the HVAC intake port 60 and the HVAC blow port 61. By operation of the HVAC blower 63, the air 10 from the vehicle interior or vehicle exterior is taken through the HVAC intake port 60 and sent to the vehicle interior through the HVAC blow port 61. Although not shown, devices for heating and/or cooling the air 10, such as a compressor, an evaporator, and a heat exchanger, are arranged between the HVAC intake port 60 and the HVAC blow port 61.

The HVAC blow port 61 includes a plurality of blow ports including the defroster. By operating a switch (not shown) mounted on the vehicle, the flow path within the HVAC duct 62 can be switched to blow the air 10 from the defroster. When a signal indicating that the switch has been operated is input, the flow rate controller 5 can control the dehumidified air flow rate ratio as described above.

The humidity controlling device 2 is provided inside a humidity controlling duct configured to allow the air 10 from the vehicle interior or the vehicle exterior to flow therethrough. The humidity controlling duct 23 is provided outside the HVAC unit 6. The humidity controlling duct 23 has a vehicle interior flow path 230 for allowing the air 10 that has passed through the humidity controlling device 2 to flow into the vehicle interior, and a vehicle exterior flow path 231 for allowing the air 10 that has passed through the humidity controlling device 2 to be discharged to the vehicle exterior. The vehicle interior flow path 230 and the vehicle exterior flow path 231 are separated from each other by a duct partition wall 232. Although not shown, the vehicle interior flow path 230 and the vehicle exterior flow path 231 may be provided at a distance from each other.

The humidity controlling duct 23 and the HVAC intake port 60 are provided so that the HVAC intake port 60 can intake both the air 10 outside the humidity controlling duct 23 and the air 10 that has passed through the vehicle interior flow path 230. The first flow path 3 for feeding the air 10 into the vehicle interior without passing through the humidity controlling device 2 includes a space outside the humidity controlling duct 23, and the second flow path 4 for feeding the air 10 that has passed through the humidity controlling device 2 to the vehicle interior includes the vehicle interior flow path 230.

The flow rate controller 5 includes a humidity controlling blower 50 for feeding the air 10 to the humidity controlling device 2. The humidity controlling blower 50 is disposed upstream of the humidity controlling device 2 in the flow direction of the air 10. The humidity controlling blower 50 is disposed inside the humidity controlling duct 23. By increasing an operation amount of the humidity controlling blower 50, the flow rate of the air 10 passing through the second flow path 4 can be increased, and the dehumidified air flow rate ratio can be increased.

In addition, when the operation amount of the HVAC blower 63 is increased, not only the flow rate of the air 10 passing through the second flow path 4 but also the flow rate of the air 10 passing through the first flow path 3 increases. By controlling the ratio of the operation amounts of the HVAC blower 63 and the humidity controlling blower 50, the dehumidified air flow rate ratio can be controlled. The flow rate controller 5 may include the HVAC blower 63.

The flow rate controller 5 preferably has the dehumidified air flow rate ratio of 7% or more, and more preferably the dehumidified air flow rate ratio of 15% or more. The dehumidified air flow rate ratio is more than or equal to that value, the fogging on the inner surface of the vehicle windshield can be more reliably removed.

The vehicle air conditioning system 1 may further include a humidity sensor 7 that measures the humidity in the vehicle interior. The flow rate controller 5 may change the dehumidified air flow rate ratio based on the humidity measured by the humidity sensor 7. The flow rate controller 5 may increase the dehumidified air flow rate ratio as the humidity measured by the humidity sensor 7 is higher. This allows for more dehumidification when the humidity in the vehicle interior is higher. For example, when the humidity measured by the humidity sensor 7 is 50% or higher, the dehumidified air flow rate ratio may be 10%, and when the humidity measured by the humidity sensor 7 is 60% or higher, the dehumidified air flow rate ratio may be 15%. The humidity sensor 7 may be located at any position. The humidity sensor 7 may be located in the vehicle interior or in a flow path through which the air 10 from the vehicle interior is passed. The humidity sensor 7 can measure relative humidity.

The humidity controlling device 2 may further have a heating means 21 configured to heat the adsorption portion. Heating of the adsorption portion 20 by the heating means 21 desorbs the moisture from the adsorbent in the adsorption portion 20.

The vehicle air conditioning system 1 can have a switching valve 8 that can switch the flow of the air 10 flowing through the humidity controlling duct 23 between the vehicle interior flow path 230 and a vehicle interior flow path 231. The switching valve 8 can cause the air 10 to flow into the vehicle interior flow path 230 when the moisture in the air 10 is adsorbed to the humidity controlling device 2, and can cause the air 10 to flow into the vehicle exterior flow path 231 when the moisture is desorbed from the moisture controlling device 2. FIG. 1 shows the air 10 being allowed to flow into the vehicle interior flow path 230. It is intended that the air 10 flowing through the vehicle interior flow path 230 is fed to the vehicle interior through the HVAC unit 6, and the air 10 flowing through the vehicle exterior flow path 231 is discharged to the vehicle exterior without passing through the HVAC unit 6. The outlet of the vehicle exterior flow path 231 may be positioned so as to be displaced from the HVAC intake port 60.

The switching of the switching valve 8 can be performed, for example, by electrically connecting the control unit 80 to the switching valve 8 by the electric wire 81 or wirelessly, and operating a switch (not shown) of the switching valve 8 by the control unit 80. The switching valve 8 is not particularly limited as long as it is a valve that is electrically driven and has the function of switching the flow path, and includes electromagnetic valves and electric valves. In an embodiment, the switching valve 8 includes an opening/closing door 83 supported by a rotating shaft 82 and an actuator 84 such as a motor that rotates the rotating shaft 82. The actuator 84 is configured to be controllable by the control unit 80.

The vehicle air conditioning system 1 may have a control unit 80 that controls the humidity controlling device 2, the switching valve 8, and the humidity controlling blower 50. A control mode of the control unit 80 include an adsorption mode in which the humidity controlling blower 50 is activated without activating the heating means 21 to cause the air 10 to flow into the vehicle interior flow path 230, and a regeneration mode in which the humidity controlling blower 50 and the heating means 21 are activated to cause the air 10 to flow into the vehicle exterior flow path 231. When the adsorption mode is performed and the air 10 is blown from the defroster into the vehicle interior, the flow rate controller 5 can set the dehumidified air flow rate ratio to be more than or equal to the above value.

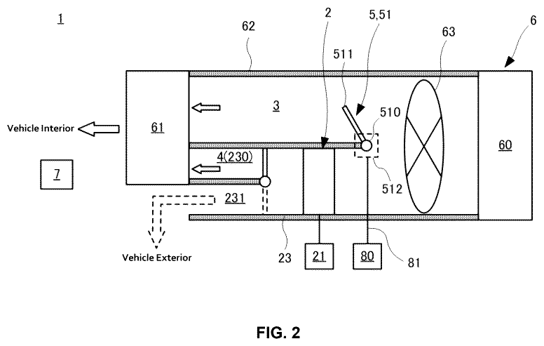

FIG. 2 is a schematic view illustrating a variation of a vehicle air conditioning system 1 in FIG. 1. In the embodiment illustrated in FIG. 1, the humidity controlling device 2 is disposed outside the HVAC unit 6. However, as illustrated in FIG. 2, the humidity controlling device 2 may be disposed inside the HVAC unit 6.

The humidity controlling device 2 is disposed inside the HVAC duct 62 so as to be located downstream of the HVAC intake port 60 and the HVAC blower 63 in the flow direction of the air 10. The humidity controlling duct 23 with the humidity control device 2 disposed therein is provided inside the HVAC duct 62. The humidity controlling duct 23 may share a portion of a wall with the HVAC duct 62. The first flow path 3 for feeding the air 10 into the vehicle interior without passing through the humidity controlling device 2 includes spaces inside the HVAC duct and outside the humidity controlling duct 23, and the second flow path 4 for feeding the air 10 that has passed through the humidity controlling device 2 to the vehicle interior includes the vehicle interior flow path 230. The air 10 flowing through the vehicle interior flow path 231 is discharged to the vehicle exterior without passing through the HVAC blow port 61.

The flow rate controller 5 includes a flow rate controlling valve 51 provided in the first flow path 3. The flow rate controlling valve 51 can limit the flow rate of the air 10 flowing through the first flow path 3 by at least partially closing the first flow path 3. By increasing the closing degree of the flow control valve 51, the flow rate of the air 10 passing through the first flow path 3 can be reduced, and the dehumidified air flow rate ratio can be increased. By controlling the operation amount of the HVAC blower 63 and the closing degree of the flow rate controlling valve 51, the dehumidified air flow rate ratio can be controlled.

The flow rate controlling valve 51 may be configured in any manner. In an embodiment, the flow rate controlling valve 51 includes an opening/closing door 511 supported by a rotating shaft 510 and an actuator 512 such as a motor that rotates the rotating shaft 510. The actuator 512 is configured to be controllable by the control unit 80.

Although not shown, the humidity controlling blower 50 may be added to the interior of the humidity controlling duct 23 as in the embodiment of FIG. 1, and the dehumidified air flow rate ratio may be controlled by both the humidity controlling blower 50 and the flow rate controlling valve 51. Other configurations are the same as those of FIG. 1.

### (2. Regarding Humidity Controlling Device)

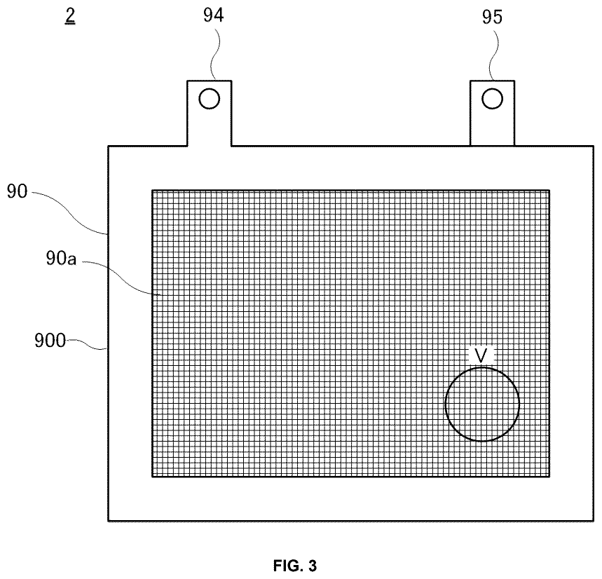

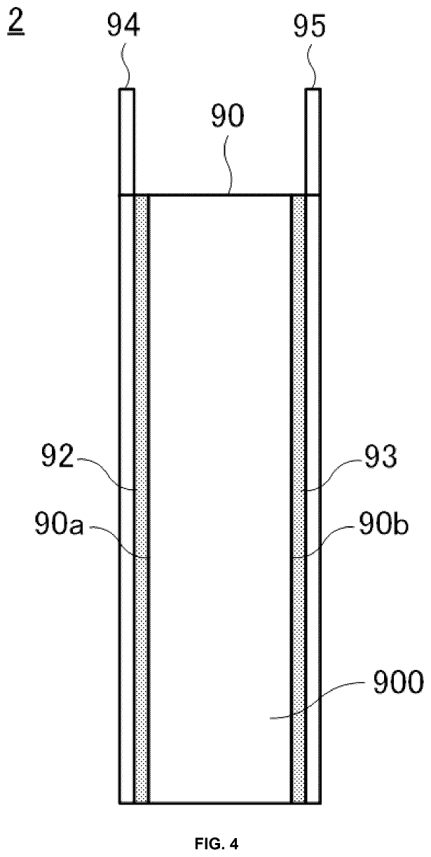

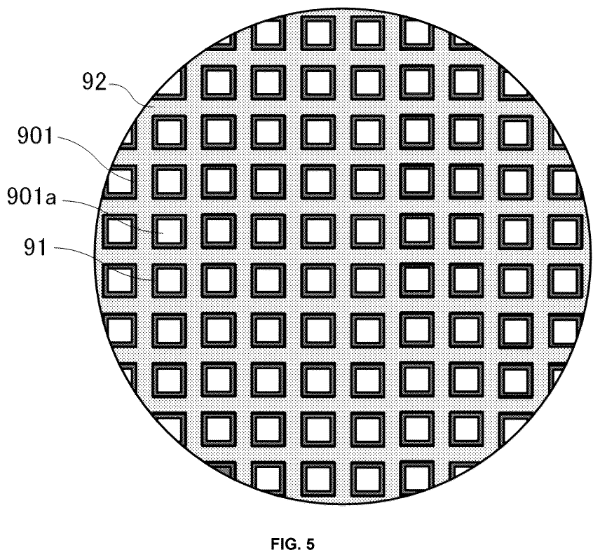

Next, FIG. 3 is a front view illustrating the humidity controlling device 2 in FIG. 1, FIG. 4 is a right side view illustrating the humidity controlling device 2 in FIG. 3, and FIG. 5 is an enlarged view illustrating the region V in FIG. 3.

As illustrated in FIGS. 3 to 5, the adsorption portion 20 of the humidity controlling device 2 according to this embodiment has a honeycomb structure 90 and an adsorbing layer 91. The honeycomb structure 90 includes: an outer wall 900; and partition walls 901 provided on an inner side of the outer wall 900, the partition walls 701 defining cells 901a to form flow paths for the air 10 each extending from a first end face 90a to a second end face 90b of the honeycomb structure 90. The adsorbing layer 91 is a layer containing the adsorbent as described above, and is provided on each surface of the partition walls 901 as illustrated in FIG. 5. As the air 10 passes through the cells 901a between the first end face 90a and the second end face 90b, the moisture in the air 10 is adsorbed by the adsorbent in the adsorbing layer 91.

In such a humidity controlling device 2, the heating means 21 has a pair of electrodes 92, 93 connected to the honeycomb structure 90, and heats the honeycomb structure 90 by applying an electric current to the honeycomb structure 90 through the pair of electrodes 92, 93. Hereinafter, when the pair of electrodes 92, 93 are to be distinguished from each other, one will be referred to as a first electrode 92 and the other as a second electrode 93.

As particularly illustrated in FIG. 4, the first electrode 92 is provided on the first end face 90a of the honeycomb structure 90, and the second electrode 93 is provided on the second end face 90b of the honeycomb structure 90. The first electrode 92 and the second electrode 93 are provided on the end face of the outer wall 900, and also provided on the end face of the partition walls 901 as illustrated in FIG. 5. On the first electrode 92 and on the second electrode 93, the cells 901a are not plugged. However, a part of cells 901a may be plugged on the first electrode 92 and/or by the second electrode 93.

As shown in FIGS. 3 and 4, a first metal terminal 94 may be provided on the first electrode 92, and a second metal terminal 95 may be provided on the second electrode 93. The first metal terminal 94 and the second metal terminal 95 are formed as rectangular frames attached to the outer peripheral portions of the first end face 90a and the second end face 90b, respectively. The first metal terminal 94 and the second metal terminal 95 are provided with extending portions each extending from the rectangular frame outward in the width direction of the honeycomb structure 90.

A positive electrode of a power source (not shown) is connected to one extending portion of the first metal terminal 94 and the second metal terminal 95, and a negative electrode of the power source is connected to the other extending portion of the first metal terminal 94 and the second metal terminal 95. Assuming that the positive electrode is connected to an extending portion of the first metal terminal 94 and the negative electrode is connected to an extending portion of the second metal terminal 95, the current from the first metal terminal 94 spreads over the first end face 90a through the first electrode 92, flows through the honeycomb structure 90 in the extending direction of the cells 901a, and flows on the second end face 90b through the second terminal 93 into the second metal terminal 95. The current flows in such a manner, thereby heating the honeycomb structure 90 uniformly.

The honeycomb structure 90 may be a honeycomb structure in which at least the partition walls 901 are made of a material having a PTC (Positive Temperature Coefficient) property. Further, the material having the PTC property has characteristics such that when the temperature increases to exceed the Curie point, the resistance value is sharply increased, making it difficult for electricity to flow.

Hereinafter, each of the components of the humidity controlling device 2 will be described in detail.

### (2-1. Regarding Honeycomb Structure)

The shape of the honeycomb structure 90 is not particularly limited. For example, an outer shape of a cross section of the honeycomb structure 90 orthogonal to the flow path direction (extending direction of the cells 901a) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 90a and second end face 90b) have the same shape as the cross section. Also, when the cross section and the end faces are polygonal, the corners may be chamfered.

The shape of each cell 901a is not particularly limited, but it may be polygonal such as quadrangular, pentagonal, hexagonal, heptagonal, and octagonal, circular, or oval in the cross section of the honeycomb structure 90 orthogonal to the flow path direction. These shapes may be alone or in combination of two or more. Moreover, among these shapes, the quadrangle or the hexagon is preferable. By providing the cells 901a having such a shape, it is possible to reduce the pressure loss when the air 10 flows. In FIGS. 3 to 5, the honeycomb structure 90 is illustrated as an example in which the outer shape of the cross section and the shape of each cell 901a are quadrangular in the cross section orthogonal to the flow path direction.

The honeycomb structure 90 may be a honeycomb joined body that includes a plurality of honeycomb segments and joining layers that join outer peripheral side surfaces of the plurality of honeycomb segments together. The use of the honeycomb joined body can increase the total cross-sectional area of the cells 901a, which is important for ensuring the flow rate of the air 10, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer wall 900 and the partition walls 901. In addition to the role of joining the honeycomb segments to each other, the joining material can also be used as an outer peripheral coating material after joining the honeycomb segments.

From the viewpoints of ensuring the strength of the honeycomb structure 90, reducing pressure loss when the air 10 passes through the cells 901a, ensuring the amount of functional material supported, and ensuring the contact area with the air 10 flowing inside the cells 901a, it is desirable to suitably combine a thickness of the partition wall 901, a cell density, and a cell pitch (or an opening ratio of the cells).

As used herein, the cell density refers to a value obtained by dividing a number of cells by an area of one end face (first end face 90a or second end face 90b) of the honeycomb structure 90 (the total area of the partition walls 901 and the cells 901a excluding the outer wall 900).

As used herein, the cell pitch refers to a value obtained by the following calculation. First, the area of one end face (first end face 90a or second end face 90b) of the honeycomb structure 90 (the total area of the partition walls 901 and the cells 901a excluding the outer wall 900) is divided by the number of the cells to calculate an area per a cell. A square root of the area per a cell is then calculated, and this is determined to be the cell pitch.

As used herein, the opening ratio of the cells refers a value obtained by dividing the total area of the cells 901a defined by the partition walls 901 by the area of one end face (first end face 90a or second end face 90b) (the total area of the partition walls 901 and the cells 901a excluding the outer wall 900) in the cross section orthogonal to the flow path direction of the honeycomb structure 90. In addition, when calculating the opening ratio of the cells 901a, the first electrode 92, the second electrode 93, and an adsorbing layer 91 as described below are not taken into consideration.

In an embodiment that is advantageous from the viewpoint of supporting a sufficient amount of functional material, the thickness of the partition walls 901 is 0.300 mm or less, the cell density is 140 cells/cm² or less, and the cell pitch is 0.85 mm or more. In a preferred embodiment, the thickness of the partition walls 901 is 0.200 mm or less, the cell density is 120 cells/cm² or less, and the cell pitch is 0.91 mm or more. In a more preferred embodiment, the thickness of the partition walls 901 is 0.160 mm or less, the cell density is 110 cells/cm² or less, and the cell pitch is 0.95 mm or more.

In each embodiment as described above, from the viewpoints of ensuring the strength of the honeycomb structure 90 and maintaining lower electrical resistance, the lower limit of the thickness of the partition walls 901 is preferably 0.010 mm or more, more preferably 0.020 mm or more, and even more preferably 0.030 mm or more.

In each embodiment as described above, from the viewpoints of ensuring the strength of the honeycomb structure 90, maintaining lower electrical resistance, and increasing a surface area to facilitate reaction, adsorption, and separation, the lower limit of the cell density is preferably 30 cells/cm² or more, more preferably 35 cells/cm² or more, and even more preferably 40 cells/cm² or more.

In each embodiment as described above, from the viewpoints of ensuring the strength of the honeycomb structure 90, maintaining lower electrical resistance and increasing a surface area to facilitate reaction, adsorption and release, the upper limit of the cell pitch is preferably 2.0 mm or less, more preferably 1.8 mm or less, and even more preferably 1.6 mm or less.

In an embodiment that is advantageous in terms of both reducing pressure loss and maintaining strength, the thickness of the partition walls 901 is 0.08 to 0.36 mm, the cell density is 2.54 to 140 cells/cm², and the opening ratio of the cells 901a is 0.70 or more. In a preferred embodiment, the thickness of the partition walls 901 is 0.09 to 0.35 mm, the cell density is 15 to 100 cells/cm², and the opening ratio of the cells 901a is 0.80 or more. In a more preferred embodiment, the thickness of the partition walls 901 is 0.14 to 0.30 mm, the cell density is 20 to 90 cells/cm², and the opening ratio of the cells 901a is 0.85 or more.

In each embodiment as described above, from the viewpoint of ensuring the strength of the honeycomb structure 90, the upper limit of the opening ratio of the cells 901a is preferably 0.94 or less, more preferably 0.92 or less, and even more preferably 0.90 or less.

Although the thickness of the outer wall 900 is not particularly limited, it is preferably determined based on the following considerations. First, from the viewpoint of reinforcing the honeycomb structure 90, the thickness of the outer wall 900 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer wall 900 is preferably 1.0 mm or less, more preferably 0.5 mm, even more preferably 0.4 mm or less, and still more preferably 0.3 mm or less.

As used herein, the thickness of the outer wall 900 refers to a length, in a normal line direction of a side surface of the honeycomb structure 90, from a boundary between the outer wall 900 and the outermost cell 901a or the partition wall 901 to the side surface of the honeycomb structure 90 in the cross section orthogonal to the flow path direction of the honeycomb structure 90.

The length of the honeycomb structure 90 in the flow path direction and the cross-sectional area orthogonal to the flow path direction may be adjusted according to the required size of the humidity controlling device 2, and are not particularly limited. For example, when used in a compact humidity controlling device 2 while ensuring a predetermined function, the honeycomb structure 90 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm².

The partition walls 901 forming the honeycomb structure 90 are made of a material that can be heated by electric conduction, specifically made of a material having the PTC property. Further, the outer wall 900 may also be made of a material having a PTC property, as with the partition walls 901, as needed. By such a configuration, the adsorbing layer 91 can be directly heated by heat transfer from the heat-generating partition walls 901 (and optionally the outer wall 900). Further, the material having the PTC property has characteristics such that when the temperature increases to exceed the Curie point, the resistance value is sharply increased, making it difficult for electricity to flow. Therefore, when the temperature of the humidity controlling device 2 becomes high, the partition walls 901 (and the outer wall 900 if necessary) have limited current flowing through them, thereby suppressing excessive heat generation of the humidity controlling device 2. Therefore, it is possible to suppress thermal deterioration of the adsorbing layer 91 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 170 Ω·cm or less, and more preferably 160 Ω·cm or less, and even more preferably 150 Ω·cm or less. As used herein, the volume resistivity at 25° C. of the material having the PTC property is measured according to JIS K 6271: 2008.

From the viewpoints of creating a device that can be heated by electric conduction and have the PTC property, the outer wall 900 and the partition walls 901 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystal grains is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer wall 900 and the partition walls 901 are substantially free of lead (Pb). Specifically, the outer wall 900 and the partition walls 901 preferably have a Pb content of 0.01% by mass or less, and more preferably 0.001% by mass or less, and still more preferably 0% by mass. The lower Pb content can allow the air 10 heated by contact with the heat-generating partition walls 901 to be safely applied to organisms such as humans, for example. In the outer wall 900 and the partition walls 901, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

In terms of efficiently heating the air, the material making up the outer wall 900 and the partition walls 901 preferably have a lower limit of a Curie point of 80° C. or more, more preferably 80° C. or more, and even more preferably 100° C. or more. Further, in terms of safety as a component placed in the vehicle interior or near the vehicle interior, the upper limit of the Curie point is preferably 250° C. or more, more preferably 225° C. or more, even more preferably 200° C. or more, and still more preferably 150° C. or more.

The Curie point of the material making up the outer wall 900 and the partition walls 901 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### (2-2. Regarding First Electrode and Second Electrode)

The first electrode 92 and the second electrode 93 are provided on the first end face 90a and the second end face 90b, respectively. Applying a voltage between the first electrode 92 and the second electrode 93 allows the honeycomb structure 90 to generate heat by Joule heat.

The first electrode 92 and the second electrode 93 may employ, for example, a metal or alloy containing at least one selected from Cu, Ag, Al, Ni and Si, although not particularly limited thereto. It is also possible to use an ohmic electrode capable of ohmic contact with the outer wall 900 and/or the partition walls 901 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the first electrode 92 and the second electrode 93 may have a single-layer structure, or may have a laminated structure of two or more layers. When the first electrode 92 and the second electrode 93 have the laminated structure of two or more layers, the materials of the respective layers may be of the same type or of different types.

The thicknesses of the first electrode 92 and the second electrode 93 may be appropriately set according to the method for forming the first electrode 92 and the second electrode 93. The method for forming the first electrode 92 and the second electrode 93 includes metal deposition methods such as sputtering, vapor deposition, electrolytic deposition, and chemical deposition. Alternatively, the first electrode 92 and the second electrode 93 can be formed by applying an electrode paste and then baking it, or by thermal spraying. Furthermore, the first electrode 92 and the second electrode 93 may be formed by joining metal sheets or alloy sheets.

Each thickness of the first electrode 92 and the second electrode 93 is, for example, about 5 to 30 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (2-3. Regarding First Metal Terminal and Second Metal Terminal)

The provision of the first metal terminal 94 and the second metal terminal 95 facilitates connection to an external power source. The first metal terminal 94 and the second metal terminal 95 are connected to a conductor connected to the external power source.

The metal that makes up the first metal terminal 94 and the second metal terminal 95 may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze. Furthermore, the thickness of each of the first metal terminal 94 and the second metal terminal 95 is not particularly limited, but it is, for example, 0.01 to 10 mm, typically 0.05 to 5 mm.

The method of connecting the first metal terminal 94 and the second metal terminal 95 to the first electrode 92 and the second electrode 93, respectively, is not particularly limited as long as they are electrically connected. For example, they can be connected by diffusion bonding, a mechanical pressing mechanism, welding, or the like.

### (2-4. Regarding Intermediate Material)

Intermediate materials may be provided between: the first electrode 92 and the second electrode 93; and the first metal terminal 94 and the second metal terminal 95. The provision of the intermediate materials results in high structural freedom of the connection between the first electrode 92 and the second electrode 93 and the first metal terminal 94 and the second metal terminal 95. The intermediate material may be made of non-limiting materials, and it may be the same as the material of the first metal terminal 94 and the second metal terminal 95 as described above. Moreover, the material of the intermediate material may be different from that of the first metal terminal 94 and the second metal terminal 95 as described above. In this case, the intermediate material can be made of a solder, a brazing material, a conductive adhesive, or the like. The method of connecting the intermediate materials to the first metal terminal 94 and the second metal terminal 95 and the first electrode 92 and the second electrode 93 is not particularly limited as long as they are electrically connected. For example, they can be connected by diffusion bonding, a mechanical pressing mechanism, welding, or the like.

### (2-5. Regarding Adsorbing Layer)

As illustrated in FIG. 5, the humidity controlling device 2 may be provided with an adsorbing layer 91 on each surface of the partition walls 901. The adsorbing layer 91 can be provided on the surfaces of the partition walls 901 (in the case of the outermost cells 901a, the partition walls 901 that define the outermost cells 901a and the outer wall 900). By thus providing the adsorbing layer 91, the functional material contained in the adsorbing layer 91 can be easily heated, so that the desired function due to the functional material can be exerted.

The adsorbent contained in the adsorbing layer 91 is not particularly limited as long as it can exhibit the desired function. The adsorbent has a function of adsorbing moisture, carbon dioxide and/or volatile components in the air. The adsorbing layer 91 may further contain a catalyst. This can allow the adsorption target substances to be purified. By using the adsorbent in combination with the catalyst, the function of the adsorbent to capture the adsorption target substances can be improved.

The adsorbent preferably has a function that can adsorb the adsorption target substances, for example, moisture, carbon dioxide and volatile components, etc., at −20 to 40° C. and desorb them at an elevated temperature of 60° C. or more. Examples of the adsorbent having such a function include zeolite, silica gel, activated carbon, alumina, silica, low-crystalline clay, amorphous aluminum silicate complexes, and the like. The type of the adsorbent may be appropriately selected depending on the types of the adsorption target substances. The adsorbent may be used alone, or in combination with two or more types.

The catalyst preferably has a function capable of promoting the oxidation-reduction reaction. The catalyst having such a function includes metal catalysts such as Pt, Pd and Ag, and oxide catalysts such as CeO₂ and ZrO₂. The catalyst may be used alone or in combination of two or more types.

The volatile components contained in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the adsorbing layer 91 may be determined according to the size of the cells 901a, and is not particularly limited. For example, from the viewpoint of ensuring sufficient contact with the air 10, the thickness of the adsorbing layer 91 is preferably 20 μm or more, more preferably 25 μm or more, and even more preferably 30 μm or more. On the other hand, from the viewpoint of suppressing separation of the adsorbing layer 91 from the partition walls 901 and the outer wall 900, the thickness of the adsorbing layer 91 is preferably 400 μm or less, more preferably 380 μm or less, and even more preferably 350 μm or less.

The thickness of the adsorbing layer 91 is measured using the following procedure. Any cross section of the honeycomb structure 90 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 90. The thickness of each adsorbing layer 91 visually recognized from the cross-sectional image is calculated by dividing the cross-sectional area by the length of the cells 901a in the flow path direction. This calculation is performed for all the adsorbing layers 91 visually recognized from the cross-sectional image, and an average value thereof is determined to be the thickness of the adsorbing layer 91.

From the viewpoint that the functional material exerts a desired function in the humidity controlling device 2, an amount of the adsorbing layer 91 is preferably 50 to 500 g/L, more preferably 100 to 400 g/L, and even more preferably 150 to 350 g/L, based on the volume of the honeycomb structure 90. It should be noted that the volume of the honeycomb structure 90 is a value determined by the external dimensions of the honeycomb structure 90.

### (3. Regarding Method for Producing Humidity Controlling Device)

The method for producing the humidity controlling device 2 according to an embodiment of the invention is not particularly limited as long as it is a method having the characteristics as described above, and can be carried out in accordance with a known method. Hereinafter, the method for producing the humidity controlling device 2 according to an embodiment of the invention will be specifically described.

A method for producing the honeycomb structure forming the humidity controlling device 2 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 90 containing, as a main component, BaTiO₃-based crystal particles in which a part of Ba is substituted with the rare earth element.

Further, maintaining the temperature of the honeycomb formed body of 1150 to 1250° C. can allow the Ba₂TiO₄ crystal particles generated in the firing process to be easily removed, so that the honeycomb structure 90 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 90.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a honeycomb structure 90 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The first electrode 92 and the second electrode 93 are formed on the honeycomb structure 90 thus obtained, whereby the humidity controlling device 2 can be produced. The first electrode 92 and the second electrode 93 can also be formed by metal deposition methods such as sputtering, vapor deposition, electrolytic deposition, and chemical deposition. Further, the first electrode 92 and the second electrode 93 can also be formed by applying an electrode paste and then baking it. Furthermore, the first electrode 92 and the second electrode 93 can also be formed by thermal spraying. The first electrode 92 and the second electrode 93 may be composed of a single layer, but may also be composed of a plurality of electrode layers having different compositions. A typical method for forming the first electrode 92 and the second electrode 93 will be described below.

First, an electrode slurry containing an electrode material, an organic binder, and a dispersion medium is prepared, and the first end face 90a or the second end face 90b of the honeycomb structure 90 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 90 is removed by blowing and wiping. The slurry can be then dried to form the first electrode 92 and the second electrode 93 on the first end face 90a or the second end face 90b of the honeycomb structure 90. The drying can be performed while heating the humidity controlling device 2 to a temperature of about 120 to 600° C., for example. Although a series of steps of coating, slurry removal, and drying may be performed only once, the steps can be repeated multiple times to provide the first electrode 92 and the second electrode 93 having desired thicknesses.

The first metal terminal 94 and the second metal terminal 95 are then placed at predetermined positions of the first electrode 92 and the second electrode 93, respectively, and the first electrode 92 and the second electrode 93 are connected to the first metal terminal 94 and the second metal terminal 95, respectively. As a method of connecting the first electrode 92 and the second electrode 93 to the terminals, the method described above can be used. Further, when the intermediate materials are provided between: the first electrode 92 and the second electrode 93; and the first metal terminal 94 and the second metal terminal 95, the intermediate material can be placed at a predetermined position of the first electrode 92 and the second electrode 93 and connected to each other, and then the first metal terminal 94 and the second metal terminal 95 can be placed at a predetermined position of the intermediate material and connected to each other. As a method for connecting these, the method as described above can be used.

It should be noted that the first metal terminal 94, the second metal terminal 95 and the intermediate material may be provided after the adsorbing layer 91 described below is formed.

The adsorbing layer 91 is then formed on each surface of the partition walls 901 and the like of the humidity controlling device 2 thus obtained, thereby obtaining a humidity controlling device with functional material-containing layers.

Although the method for forming the adsorbing layer 91 is not particularly limited, it can be formed, for example, by the following steps. The humidity controlling device 2 is immersed in a slurry containing a functional material, an organic binder, and a dispersion medium for a predetermined period of time, and an excess slurry on the end faces and the outer periphery of the honeycomb structure 90 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 91 on the surfaces of the partition walls 901. The drying can be performed while heating the humidity controlling device 2 to a temperature of about 120 to 600° C., for example. Although a series of steps of immersion, slurry removal, and drying may be performed only once, the steps can be repeated multiple times to provide the adsorbing layer 91 having the desired thickness on the surfaces of the partition walls 901 and the like.

### (4. Regarding Method for Controlling Vehicle Air Conditioning System)

The method for controlling a vehicle air conditioning system 1 is a method for controlling a vehicle air conditioning system 1 including: a humidity controlling device 2 having an adsorption portion 20 containing an adsorbent configured to adsorb moisture at a temperature lower than or equal to a predetermined temperature and to desorb the moisture when the temperature exceeds the predetermined temperature; a first flow path 3 for feeding air 10 from a vehicle interior or a vehicle exterior to the vehicle interior without passing through the humidity controlling device 2; and a second flow path 4 for feeding the air 10 through the humidity controlling device 2 to the vehicle interior, wherein the method includes controlling a flow rate of the air 10 passing through the first flow path 3 and/or the second flow path 4 so that, when the air 10 to the vehicle interior is blown out from a defroster, a dehumidified air flow rate ratio, which is a ratio of a flow rate of the air 10 passing through the second flow path 4 to a total flow rate of the air 10 passing through the first flow path 3 and the second flow path 4, is 5% or more. Details are as described above for the vehicle air conditioning system 1.

While the preferred embodiments of the invention have been described above in detail with reference to the drawings, the present invention is not limited to such embodiments. It is obvious that a person skilled in the art to which this invention belongs can arrive at various variations or modifications in the scope of the technical idea recited in the claims, and it is understood that they also belong to the technical scope of this invention.

### EXAMPLES

The invention will be more specifically described by means of the following Examples. The invention is not limited to these examples.

As ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.
Shape of cross section and end face of honeycomb structure orthogonal to flow path direction: quadrangular;
Dimensions of honeycomb structure: horizontal width of 114 mm, vertical width of 114 mm, length of 10 mm;
Shape of cross section of cells orthogonal to flow path direction: quadrangular;
Thickness of partition walls: 0.127 mm;
Thickness of outer peripheral wall: 0.8 mm;
Cell density: 85.3 cells/cm²;
Cell pitch: 1.08 mm;
Opening Ratio of Cells: 0.55 to 0.80;
Cross-sectional area of honeycomb structure orthogonal to flow path direction: 13000 mm²;
Length of honeycomb structure in flow path direction: 10 mm;
Volume resistivity of materials making up partition walls (and outer peripheral wall) at 25° C.: 12 Ω·cm; and
Curie point of material making up partition walls (and outer peripheral wall): 120° C.

The volume resistivity of the partition walls was controlled by adjusting the mixing ratio of the raw materials and firing conditions.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The first electrode and the second electrode each having a thickness of 0.05 mm were formed on both end faces (first end face and second end face) of the resulting honeycomb structure, respectively. The first electrode and the second electrode were formed as follows: First, an electrode slurry containing aluminum (electrode material), ethyl cellulose and diethylene glycol monobutyl ether (organic binder) was prepared and applied to the first end face. Subsequently, an excess electrode slurry on the outer periphery of the honeycomb structure was removed by blowing and wiping, and the electrode slurry was then dried to form an electrode on one end face. Similarly, an electrode was formed on the other end face.

The honeycomb structure with the first electrode and the second electrode formed was then immersed in a slurry containing zeolite (adsorbent) as a functional material, an organic binder, and water, and the slurry adhering to excess positions (such as the outer periphery) was removed by blowing and wiping, and then dried at about 550° C. to form a functional material-containing layer at the predetermined position.

Subsequently, the first metal terminal was joined onto the first electrode and the second metal terminal was joined onto the second electrode. The first metal terminal and the second metal terminal were joined as follows: Each of the first metal terminal and the second metal terminal used was a strip-shaped metal body made of SUS430 and having a width of 3.5 mm and a thickness of 0.7 mm. The overall outer shape of the first metal terminal and the second metal terminal was a rectangular frame shape. The first metal terminal and the second metal terminal were joined by soldering onto the first electrode and the second electrode, respectively, while aligning the outer edges of the first metal terminal and the second metal terminal with the outer edges of both end faces of the honeycomb structure, respectively.

A sample of the humidity controlling device obtained as described above was placed inside the humidity controlling duct provided outside the HVAC unit as illustrated in FIG. 1. The dimensions of each portion of the humidity controlling duct were as follows:
Inner dimensions of the duct at a position upstream of the branching position of the vehicle interior flow path and the vehicle exterior flow path: horizontal width 114 mm, vertical width 114 mm, length 200 mm;
Internal dimensions of the vehicle interior flow path: horizontal width 114 mm, vertical width 50 mm, length 100 mm;
Internal dimensions of the vehicle exterior flow path: horizontal width 114 mm, vertical width 50 mm, length 100 mm;
Distance from the end face on the downstream side of the humidity controlling device to the branching position of the vehicle interior flow path and the vehicle exterior flow path: 90 mm.

Also, the outlet of the vehicle interior flow path of the humidity controlling duct was arranged to face the HVAC intake port of the HVAC unit. The dimensions of the intake port were as follows:

Internal dimensions of the intake port of HVAC: horizontal width 114 mm, vertical width 114 mm.

In this case, the position of the outlet of the vehicle interior flow path was aligned with the position of the HVAC intake port in the horizontal direction, and the lower end position of the outlet of the vehicle interior flow path was aligned with the lower end position of the HVAC intake port in the vertical direction. That is, it was configured so that the air passed through the humidity controlling device was taken from a portion of 50 mm below the HVAC intake port in the vertical direction, and the air that did not passed through the humidity controlling device was taken from a portion of 64 mm above the HVAC intake port. The air that did not pass through the humidity controlling device had a temperature of 25° C. and a relative humidity of 30%, and the air that passed through the humidity controlling device had a temperature of 25° C. and a relative humidity of 15%.

The humidity controlling blower was disposed inside the humidity controlling duct upstream of the humidity controlling device, and the HVAC blower was disposed inside the HVAC duct of the HVAC unit. By operating the humidity controlling blower and the HVAC blower, 300 m³/h of the air was taken through the HVAC intake port. Further, the ratio of the operation amount of the humidity controlling blower and the HVAC blower was regulated to control the dehumidified air flow rate ratio (the ratio of the flow rate of the air passing through the humidity controlling duct to the total flow rate of the air taken from the HVAC intake port). In addition, the HVAC unit was operated in a blowing mode, and devices for heating and/or cooling the air, such as compressors, evaporators, and heat exchangers, were turned off.

The air taken from the HVAC intake port was blown against the windshield and side windows from the defroster provided below the windshield and/or in front of and below the side windows. The amount of the air blown from the defroster below the windshield was 210 m³/h, and the amount of the air blown from the defroster disposed in front of and below the side window was 90 m³/h. The volume of the interior space of the vehicle interior was 12 m³. Before the air was blown out from the defroster, the temperature in the interior space of the vehicle interior was 25° C. and the relative humidity was 40%, and the windshield and side windows were uniformly fogged up.

Then, while changing the dehumidified air flow rate ratio as shown in the table below, the air was blown out from the defroster for 10 minutes, and the fogging of the windshield and side windows was then visually confirmed. In the table below, “circle” indicates that the fogging on the windshield or side window was completely removed, “triangle” indicates that the area of the region that removed the fogging was 70% or more of the total area of the windshield or side window, and “x” indicates that the area of the region that removed the fogging was less than 70% of the total area of the windshield or side window. When the windshield was evaluated as “triangle” or “circle”, it was evaluated that the fogging was sufficiently removed and it was determined to be acceptable.

TABLE 1

| | |
|---|---|
| Dehumidified Air | Fogging |

| Flow Rate Ratio (%) | Windshield | Side Windows |
|---|---|---|
| 3 | x | x |
| 5 | Δ | x |
| 7 | ∘ | Δ |
| 15 | ∘ | ∘ |

As shown in the table, when the dehumidified air flow rate ratio was 3%, the windshield and side windows were evaluated as “x”. In contrast, when the dehumidified air flow rate ratio was 5%, the evaluation of the windshield was “triangle”. This could evaluate that a dehumidified air flow rate ratio of 5% or more could more reliably remove the fogging from the window glass of the vehicle. Moreover, by increasing the dehumidified air flow rate ratio to 7% and 15%, the fogging could be removed even more reliably.

### DESCRIPTION OF REFERENCE NUMERALS

1: vehicle air conditioning system
2: humidity controlling device
3: first flow path
4: second flow path
5: flow rate controller
7: humidity sensor
10: air
20: adsorption portion
21: heating means
51: flow rate controlling valve
90: honeycomb structure
90a: first end face
90b: second end face
91: adsorbing layer
92: electrode
93: electrode
900: outer wall
901: partition wall
901a: cell

1. A vehicle air conditioning system, comprising:
a humidity controlling device having an adsorption portion containing an adsorbent configured to adsorb moisture at a temperature lower than or equal to a predetermined temperature and to desorb the moisture when the temperature exceeds the predetermined temperature;
a first flow path for feeding air from a vehicle interior or a vehicle exterior to the vehicle interior without passing through the humidity controlling device;
a second flow path for feeding the air through the humidity controlling device to the vehicle interior; and
a flow rate controller for controlling a flow rate of the air passing through the first flow path and/or the second flow path so that, when the air to the vehicle interior is blown out from a defroster, a dehumidified air flow rate ratio, which is a ratio of a flow rate of the air passing through the second flow path to a total flow rate of the air passing through the first flow path and the second flow path, is 5% or more.

2. The vehicle air conditioning system according to claim 1, wherein the flow rate controller comprises a blower for feeding the air to the humidity controlling device.

3. The vehicle air conditioning system according to claim 1, wherein the flow rate controller comprises a flow rate controlling valve provided in the first flow path.

4. The vehicle air conditioning system according to claim 1, wherein the flow rate controller has the dehumidified air flow rate ratio of 7% or more.

5. The vehicle air conditioning system according to claim 4, wherein the flow rate controller has the dehumidified air flow rate ratio of 15% or more.

6. The vehicle air conditioning system according to claim 1, further comprising a humidity sensor for measuring humidity in the vehicle interior,
wherein the flow rate controller changes the dehumidified air flow rate ratio based on the humidity measured by the humidity sensor.

7. The vehicle air conditioning system according to claim 1, wherein the adsorption portion comprises:
a honeycomb structure having an outer wall and partition walls provided on an inner side of the outer wall, the partition walls defining cells to form flow paths for the air, each of the cells extending from a first end face to a second end face of the honeycomb structure; and
an adsorbing layer containing an adsorbent, the adsorbing layer being provided on a surface of each of the partition walls,
wherein the humidity controlling device has a pair of electrodes connected to the honeycomb structure, and further comprises a heating means for heating the honeycomb structure by passing a current through the honeycomb structure through the pair of electrodes, and
wherein at least the partition walls of the honeycomb structure are made of a material having a positive temperature coefficient (PTC) property.

8. A method for controlling a vehicle air conditioning system, the vehicle air conditioning system comprising: a humidity controlling device having an adsorption portion containing an adsorbent configured to adsorb moisture at a temperature lower than or equal to a predetermined temperature and to desorb the moisture when the temperature exceeds the predetermined temperature; a first flow path for feeding air from a vehicle interior or a vehicle exterior to the vehicle interior without passing through the humidity controlling device; and a second flow path for feeding the air through the humidity controlling device to the vehicle interior,
wherein the method comprises controlling a flow rate of the air passing through the first flow path and/or the second flow path so that, when the air to the vehicle interior is blown out from a defroster, a dehumidified air flow rate ratio, which is a ratio of a flow rate of the air passing through the second flow path to a total flow rate of the air passing through the first flow path and the second flow path, is 5% or more.
